(19) United States
(12) Patent Application Publication
(10) Pub. No.: US 2007/0220275 A1
(43) Pub. Date: Sep. 20, 2007

(54) WEB AUTHORIZATION BY AUTOMATED INTERACTIVE PHONE OR VoIP SESSION

(75) Inventors: Joe Heitzeberg, Seattle, WA (US); Thomas Jay Hoover, Seattle, WA (US); Nathan Kriege, Seattle, WA (US); Robert Frederick, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Snapvine, Inc., Seattle, WA (US)

(21) Appl. No.: 11/674,560

(22) Filed: Feb. 13, 2007

Related U.S. Application Data
(60) Provisional application No. 60/773,042, filed on Feb. 14, 2006.

(51) Int. Cl. H04K 1/00

(52) U.S. Cl. 713/186

(57) ABSTRACT

A system and associated apparatus and methods for providing enhanced security for transactions conducted over a network, such as eCommerce or a financial transaction conducted over the Internet. The system strengthens the security processes (e.g., user registration, authentication, and transaction acceptance or authorization) that are part of such a transaction to provide additional security for transactions conducted over a network (e.g., the Internet). The invention includes the use of a first communication channel or mode (e.g, the Internet) for entering user data and a second communication channel or mode (e.g., a response entered on a personal phone or VoIP connection) as a supplementary method of verifying the user's identity. The supplementary method may involve placing a call to a fixed line or mobile phone and requesting the user to confirm their identity by entering a alphanumeric string, speaking a password, executing a function on the device, or another similar action.

### CROSS-REFERENCE TO RELATED APPLICATIONS

The present application is related to and claims the benefit of U.S. Provisional Patent Application No. 60/773,042, entitled “Web Authorization by Automated Interactive Phone or VoIP Session”, filed Feb. 14, 2006, the contents of which are hereby incorporated by reference.

### BACKGROUND OF THE INVENTION

The present invention is directed to systems, apparatus and methods for providing security during a user registration, authentication or transaction acceptance process as part of execution of a commerce transaction, banking or other transaction conducted over a network such as the Internet.

The security aspect of functions such as user registration, authentication and transaction authorization on a network such as the Internet are important, yet subject to vulnerability. It is a common situation that users must register for a service, authenticate their identity, accept a transaction, or sign-in to web applications (among other activities) using a combination of credentials (typically usemame, password and/or email address). A recurring problem is that these credentials are subject to security vulnerabilities which may lead to identity theft, access to confidential information, or the conduct of fraudulent financial transactions. Once an unauthorized person (such as a hacker) has gained access to a user's accounts, they are able to masquerade as that person, gaining further access to private data, additional accounts and thereby the ability to cause further harm. This harm is to both the individual directly affected, and to the confidence of others in the integrity of the economic system based on eCommerce and banking transactions over the Internet.

Current methods used by unauthorized persons to gain access to user accounts and other personal data on the Internet include:

Guesswork—A person guesses the user's credentials and is able to log in to access their account;

Social engineering—a person posing as a trusted source (the eCommerce store owner, financial institution, etc.) tricks the user into revealing their credentials; and

Phishing—becoming commonplace on the Internet, in this form of attack an email posing as a trusted authority is sent to the user with a spoofed email header. This email contains an urgent message asking the user to log in to their account and includes a falsified link to a web page which looks like the official website. In this way, the user is tricked into entering their credentials into a false website from which the credentials can be accessed and used by an identity thief, for example.

Existing techniques to increase security and reduce the vulnerability of personal information include those noted below, but as recognized by the inventors and also noted, each possesses significant disadvantages:

| Method | Description | Problems Noted by Inventors |
|---|---|---|
| Enforcing | The system can | Such systems may make passwords harder for |
| strong | enforce a strong | thieves to guess but do not overcome social |
| passwords | password (lengthy, | engineering or phishing attacks. Furthermore, they |
| | not a dictionary | have the side effect that user's forget their passwords |
| | word and | resulting in a higher customer support costs and |
| | containing mixed | lower user satisfaction. Also, when passwords are |
| | alpha-numeric, for | difficult to remember, users write their passwords |
| | example). | down on paper or store them in insecure files. |
| Biometrics | The system | Deploying such systems is prohibitively expensive |
| | includes a | for all but the most highly valuable use cases, |
| | fingerprint or retina | because they require additional hardware. |
| | scanner. | Furthermore, the typical systems are fingerprint- |
| | | based or iris-based, both of which are metrics that |
| | | can be stolen (fingerprints left on wine glasses, or |
| | | iris photographed by a telephoto lens). Further, once |
| | | these credentials are stolen, they are stolen for life. |
| Smartcards | The system requires | Expensive to deploy; the user must physically carry |
| | the user to insert a | the card when they need to authenticate their |
| | specially coded | identity. |
| | card. | |

What is desired is a system and associated apparatus and methods of providing enhanced security for transactions conducted over a network, and which overcomes the disadvantages of present approaches.

### BRIEF SUMMARY OF THE INVENTION

The present invention is directed to a system and associated apparatus and methods for providing enhanced security for transactions conducted over a network, such as eCommerce or a financial transaction conducted over the Internet. The inventive system serves to strengthen the security processes (e.g., user registration, authentication, and transaction acceptance or authorization) that are part of such a transaction to provide additional security for transactions conducted over a network (e.g., the Internet). As a result, the invention provides additional protection against identity and/or financial theft that may result from unauthorized access to data entered over a network as part of accessing a web-site or conducting a transaction.

The present invention includes the use of a first communication channel or mode (e.g, the Internet) for entering user data and a second communication channel or mode (e.g., a response entered on a personal phone or VoIP connection) as a supplementary method of verifying the user's identity. The supplementary method may involve placing a call to a fixed line or mobile phone and requesting the user to confirm their identity by entering a alphanumeric string, speaking a password, executing a function on the device, or another similar action. The phone number at which the user is reached may be entered in an initial registration process for a service or transaction. The supplementary verification method may take the form of a phone call placed to a phone, PDA, or computing device over a fixed-line, mobile network, or Internet (i.e., VoIP) connection. The verification method may include a phone call or presentation of a web-page or user interface instructing the user to execute a specific action (such as activating a button or function).

In one embodiment, the present invention is directed to a method of verifying the identity of a person initiating a transaction over a network, where the method includes obtaining credential data for the person as a result of the person providing the data over a first communication channel and the data includes a telephone number for the person, contacting the person using the telephone number over a second communication channel, receiving verification data over the second communication channel, comparing the received verification data to correct verification data, and verifying the identity of the person if the received verification data matches the correct verification data.

Other objects and advantages of the present invention will be apparent to one of ordinary skill in the art upon review of the detailed description of the present invention.

### BRIEF DESCRIPTION OF THE DRAWINGS

FIG. 1 is a functional block diagram illustrating the primary functional elements of a system that may be used to implement an embodiment of the present invention;

FIG. 2 illustrates a registration process that may be utilized by a user as part of conducting a transaction in accordance with an embodiment of the present invention; and

FIG. 3 illustrates an authentication process that may be utilized by a user as part of conducting a transaction in accordance with an embodiment of the present invention.

### DETAILED DESCRIPTION OF THE INVENTION

The present invention is directed to a system and associated apparatus and methods for providing enhanced security for transactions conducted over a network, such as eCommerce or a financial transaction conducted over the Internet. In one embodiment, the present invention provides additional security for the personal data involved in such transactions by utilizing a verification or authentication step conducted over a different communication channel than that used for the entry of data used to initiate the transaction. This additional security can be used as part of one or more of the registration, authentication, identity verification, or transaction acceptance/authorization functions that may be part of obtaining access to a service or conducting a transaction. For example, the invention may be used as part of registering for and subsequently conducting a transaction using a web-site belonging to an eCommerce provider or financial institution. In this embodiment, the present invention may be used as part of a web-site authentication or identity verification function, and serves to provide added protection from the possibility of stolen credentials and successful Phishing attacks. Benefits of the present invention include, but are not limited to, being more secure than existing solutions, less costly to deploy, and places as small or a smaller level of additional burden on users.

In one embodiment, the inventive system employs a telephony network (fixed line, mobile or a VoIP connection) to provide an additional layer of security for an authentication or identity verification process. The present invention can be generally described as including the following functional processes:
Registration—at the time of initial registration (establishing an account), the user is requested to provide their phone number in addition to other requested credentials. To verify that the user is the owner of that phone number, the system may automatically dial out to the user and ask the user to confirm their registration (for example, by pressing a key, entering a phone PIN, or speaking a phrase); and
Authentication/Verification—the user logs into the system in a 2 step process. (1) The user logs in with their usual credentials. If the credentials are correctly entered, the system will then (2) automatically dial the phone number associated with the user's account and ask the user to verify that they are now logging in. The dial out process may be implemented using a Web Server, which triggers an automatic phone call using the database to retrieve the user's phone number, and a TDM, PSTN, VoIP or VoIP/PSTN connection to access the user's phone. (3) The user verifies their identity by pressing a key, entering their phone PIN, speaking a phrase, etc. If the entered data is correct, then the user is logged in; if not they are not logged in.

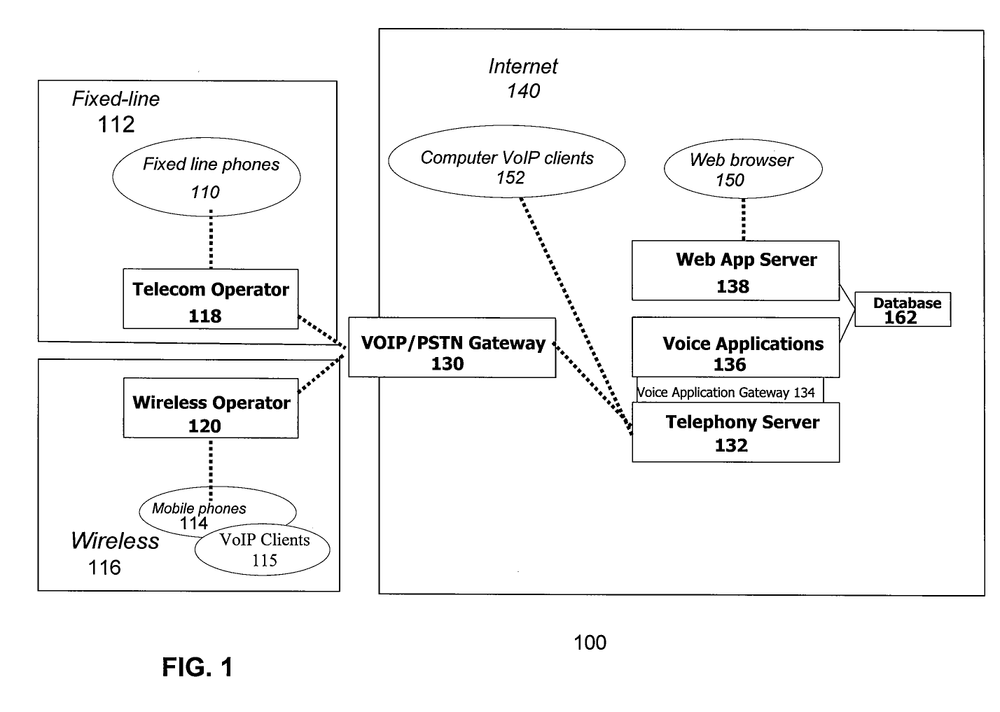

FIG. 1 is functional block diagram illustrating the primary functional elements of a system 100 that may be used to implement an embodiment of the present invention. As shown in the figure, voice messages or other audio content may be input to system 100 using a fixed line device (such as a standard telephone 110) operating over a fixed or wireline network 112, or using a mobile phone 114 operating over a wireless network 116. In the case of a fixed line network, a Telecom Operator 118 (e.g., a network operator of PSTN or legacy telephone networks and service) will receive the dialed number and process that data to permit connection to the desired end-point. Similarly, in the case of a wireless network, a Wireless Operator 120 (e.g., a network operator of wireless telephone networks and service) will perform the same or similar function.

The telephony network (either fixed line or wireless) is coupled to the Internet 140 using a VoIP/PSTN Gateway 130. Gateway 130 is a component that is typically managed by a 3rd party provider such as Level3™ or Global Crossing™, for example. Its primary function is to handle communication and data exchange between the VoIP network and the PSTN network (where the VoIP network generally refers to call sessions running over the Internet Protocol (IP) domain and processed by Internet components, and the PSTN network generally refers to call sessions running over the traditional legacy carrier networks, circuit switched and mobile phone networks, and typically connects to hardware interfaces such as fixed line and mobile phone devices).

Gateway 130 is coupled to and configured to exchange data with Telephony Server 132. Telephony Server 132 performs functions that enable audio data to be transported between the packet-switched and circuit-switched networks, such as data formatting, low level call control, assembly of IP packets into audio streams, encoding and decoding of audio data according to a set of codec and compression algorithms, negotiating handoff of call sessions with interconnected components such as VoIP/PSTN Gateway 130, and relaying commands and connections from Voice Application Gateway 134. Note that Telephony Server 132 may be implemented as a cluster of multiple physical server devices in order to distribute its load. In that case, a load balancing component would be placed between the cluster of Telephony Servers and the connection to the internet.

Voice Application Gateway 134 couples Telephony Server 132 to Voice Applications element 136 and implements a control protocol between Voice Applications element 136 and Telephony Server 132. Voice Application Gateway 134 may be used to present an abstraction of the control functions for a lower level telephony handling layer for use by the application executing as part of Voice Applications element 136. In this sense, it may present an interface or set of interfaces for use by applications to enable those applications to access and control aspects of the Telephony Server functions.

Voice Applications element 136 broadly represents applications and functions that may be (but are not required to be) used to implement certain of the basic features of the present invention. Voice Applications element 136 may include a set of instructions executed by a processing element, a state machine, or other form of instructions or commands that may be used to implement the processes or functions of the invention. This may include algorithms, heuristics, and/or data processing capabilities to implement the voice call and/or VoIP functions used in the services and features of the present invention. Voice Applications element 136 may also be used to implement certain processes of the current invention that pertain to the user experience (e.g., presentation of the appropriate user interface), provide access to application programming interfaces (APIs) used to access other elements or components of the overall system, interface with application state data, or provide billing and/or other functions or services of the overall system. Note that Voice Application element 136 and Web Application Server 138 (to be described) may share an object, memory and/or processor space (i.e. they may reside in the same logical processor space). Note also that in addition to Voice Application element 136, certain aspects of the present invention may reside in other of the functional components described (e.g., Web Application Server 138 or Voice Application Gateway 134), and that in order to make the inventive system, apparatus and methods operate and scale in a desirable manner, the components may be combined or inter-connected with other interfaces or features.

Web Application Server 138 represents an element that functions to handle requests from web browser clients 150, where such clients may be applications executing on a computing device (e.g., desktop or laptop computer) connected to the Internet. Web Application Server 138 performs processing for handling HTTP requests as well as application logic to support the functions of the present invention. Web Application Server 138 may be configured to provide user interfaces (e.g. via HTML) and application state data (e.g. via XML) to user agents (such as browser 150) over the Internet or other IP connection. In some cases, computer based VoIP Clients 152 may connect to this component directly to retrieve user interface or application state information.

Database 162 represents a data storage element that is configured to handle data storage requirements of the present invention, possibly including state data which may be utilized in implementation or other functions pertaining to the invention.

As indicated, the enhanced security function of the present invention may be accessed and/or controlled by users via several different types of devices, where those devices may be executing one or more of several types of client applications. Such devices include fixed-line phones 110 (where access and control may be provided by audio input and/or DTMF signals generated by the phone keypad), mobile or smart phones 114 executing a mobile browser or mobile VoIP client 115 (a data client in a mobile device which connects over a wireless network but communicates via IP and is capable of making a VoIP connection), or a desktop or laptop computer executing a web browser application 150 or VoIP client application 152, among others. In general, Web Browser 150 refers to a user agent capable of communicating using IP over the Internet and controlled by a user, including for example, agents like Internet Explorer, Mozilla, some types of Internet-connected mobile devices and automated processes such as web spiders. Further, in general, VoIP Clients 152 refers to a user agent capable of making a VoIP protocol connection, including for example, Skype™, Google Talk™ and other computer applications as well as web-embeddable VoIP clients.

In order to illustrate the typical operation and interactions between the system components, and to explain the mechanisms and procedures used to interface between those components when handling calls and providing the inventive process, examples of how specific calling functions may be implemented will be provided. For a computer VoIP call session initiated by a VoIP client executing on a desktop or laptop computer, a VoIP client 152 connects to Telephony Server 132 over the Internet, creating a call session. Data is encoded according to a VoIP protocol such as SIP, H323 or other suitable protocol, and audio is encoded with a given codec such as GSM or other suitable codec. Telephony Server 132 registers this connection with Voice Application element 136 using Voice Application Gateway 134 to control the connection. Voice Application element 136 executes one or more processes to handle the logical processing of the call session, for example to access database 162 or the shared object model for state information.

For a fixed line phone call session, the call originates from the user's phone device 110, and uses Telecom Operator's 118 network to connect to VoIP/PSTN Gateway 130. Gateway 130 executes one or more processes to translate the call into a packetized VoIP session, and relays this to Telephony Server 132. From that point on, the interconnection is handled in the same manner as the computer VoIP call session described above. For a dial-out connection, a call session may originate from Web Application Server 138. This component uses the shared object model to initiate a request to Telephony Server 132 using the Voice Application Gateway 134 as a control mechanism, passing the destination IP address, URL, SIP Address, phone number or other identifying destination address. Based on the nature of this address, Telephony Server 132 establishes a call session with a VoIP client 152 across the Internet, or with VoIP/PSTN Gateway 130. This session uses a VoIP protocol such as SIP, H323 or other suitable protocol, and audio is encoded with a given codec such as GSM or other suitable codec. If used, VoIP/PSTN Gateway 130 converts this VoIP session into a PSTN connection and brokers with the appropriate Telecom Operator 118 to pass the session along and terminate the call. Note that in the case of a mobile VoIP client 115 connected over a Wireless Operator 120 network, the path established is from Telephony Server 132 over the Internet to Wireless Operator 120 directly, who then subsequently proxies the IP data transmission using their own mechanisms. For a Web Browser 150 initiated session, the browser or other user agent connects over the Internet using HTTP over IP to Web Application Server 138, which in turn generates a response in a format such as HTML or XML for display and navigation using the browser.

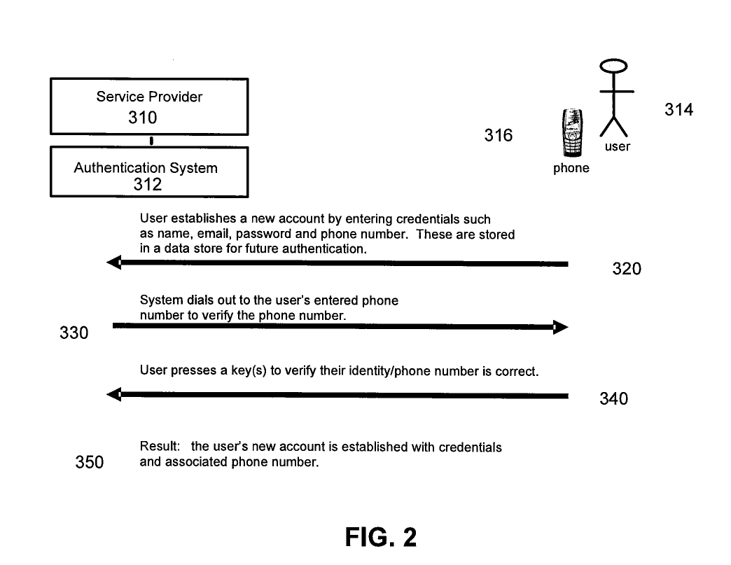

FIG. 2 illustrates a registration process that may be utilized by a user as part of conducting a transaction in accordance with an embodiment of the present invention. Note that the registration process may be performed using a web browser executing on a computing device or mobile phone, by using a fixed line phone and entering voice commands (interpreted by an interactive voice response system, for example) and/or DTMF tones using the keypad, or via a VoIP client executing on a mobile phone or computing device, among other methods. As shown in FIG. 2, a possible registration process involves a user (element 314) establishing an account or initiating a transaction with a provider of the service or transaction of interest (element 310) and may include providing a user name and password, billing information, and if required, a means for authenticating the user (such as the user's phone number) (stage 320). To verify that user 314 is the owner of that phone number, the authentication or verification system (element 312) may automatically dial out (stage 330) to the user's phone 316 and request that the user confirm their registration (for example, by pressing a key, entering a phone PIN, or speaking a phrase) (stage 340). After receipt and processing of the entered data, the new account is established (or the transaction or service delivery process is initiated) and associated with the user's phone number (stage 350).

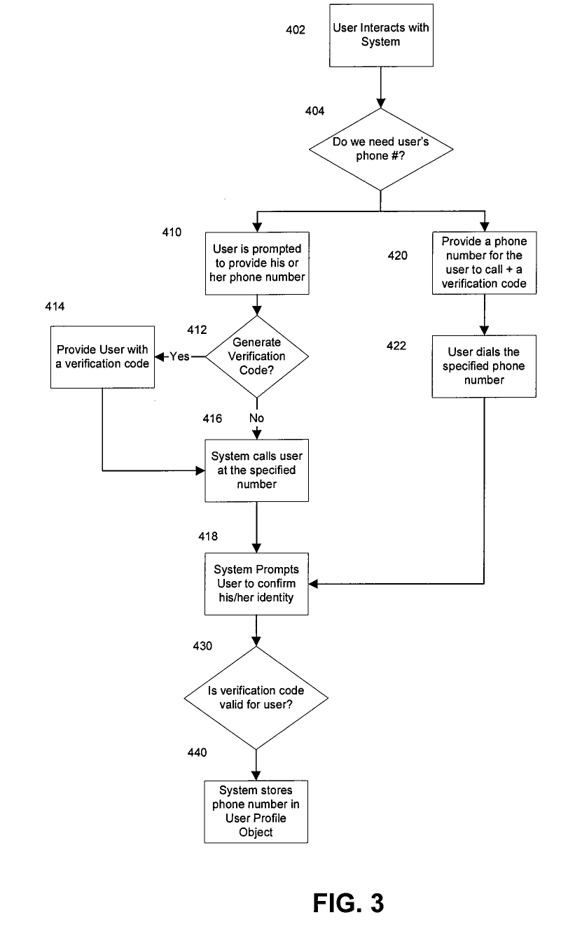

As part of a registration process and/or for subsequent attempts to conduct a transaction, initiate delivery of a service, or similar process, a user may be required to execute an authentication or verification procedure, such as that illustrated in FIG. 3. Such an authentication procedure may include, for example, requiring a user to log into a web-site in a two-step process. First, the user logs in with their usual credentials (i.e., those used to register the user and establish the account or initiate the transaction), as shown at stage 402. If the credentials are correctly entered, the web site will then determine if user's phone number is needed for the authentication process (stage 404). If the phone number is needed, then the number may be retrieved from a data storage element. Alternately, the user may be prompted to provide a phone number (stage 410) which is then stored for later access. The system then determines if a verification code is required by the authentication process (stage 412). If such a code is needed, then the user is provided with a unique verification code or string (stage 414). This verification code can be permanent or temporary. The verification code is associated with the user's phone number, creating a data-tuple stored in the system data storage.

The system then dials-out to the user at the phone number specified by the user, which is associated with the newly updated user account (stage 416). The dial out process may be implemented by the Web Application Server (element 138 of FIG. 1), which triggers an automatic phone call by accessing database 162 to retrieve the user's phone number, and utilizes a TDM, PSTN, VoIP or VoIP/PSTN network or connection as appropriate to connect to the user's phone.

If the system determines at stage 404 that the user's phone number is not needed for the authentication process, then the system may provide the user with a phone number to call and a verification code (stage 420). The user then dials the phone number provided (stage 422). After connection to the user (either via stage 416 or stage 422), the system prompts the user to confirm his/her identity (stage 418). The user verifies their identity by providing the verification code (if one is required), such as by pressing a key, entering their phone PIN or speaking a phrase. The system then determines if the entered code is correct (stage 430) by determining if the entered code is associated with the user. If the entered code is correct, then the system stores the phone number and verification results within the user profile data (stage 440). This means that the user has been verified and authenticated. Depending upon the level of authentication required by the system or service provider, this could be enough security to enable the caller to finish conducting the transaction or obtain the desired service. If the entered verification code is incorrect, then control may be passed back to stage 418. If after several attempts the correct code has not been entered, then the user is not authenticated and an error message may be generated.

Note that all or a portion of the inventive process may be implemented by a user by means of a fixed line phone, mobile phone, or VoIP connection. Thus, although registration may be accomplished via one mode of communication (fixed line, mobile phone, etc.), the verification process or a subsequent transaction verification process may occur contemporaneously or at a later time, and may be accomplished using the same or a different communication mode than that used for the registration process.

Another mode of interaction between a user and the system is by the user sending a command to the system via a SMS message generated on the user's mobile phone or PDA, followed by the user receiving a numeric string generated by the system. The user then calls the system and confirms their identity by entering the string on the phone keypad (thereby generating DTMF codes).

In general, the alphanumeric verification code or string may be entered by the user using a phone keypad (thereby generating DTMF tones), voice commands (that may be interpreted by an interactive voice response system), SMS text message, or other similar means. In addition, the alphanumeric verification code or string may be provided to the user by the system by means of a SMS message, email, voicemail message, or other communications means. The verification data may be provided by the user in response to receiving a phone call or message from the system or the user may provide the verification data by placing a call to the system followed by entering data using the keypad, sending a text message or speaking a phrase.

Note that among others, the described registration and authentication process provides the following features and advantages:
If a user's textual credentials are stolen in a phishing or social engineering attack, the thief will not be able to log into the website unless they are in physical possession of the user's actual phone;
Even if the thief knows the user's phone number, it will not help them perform an authentication since they would not be able to answer the phone at the time of authentication in order to finalize the authentication/verification process;
In situations where credentials are stolen, the thieves and victims are usually not in close proximity and thus it is highly unlikely that the thief would also have access to the user's physical phone;
The described process requires no additional cost of deployment because no special hardware is needed; and
Many people carry around their mobile phone wherever they go and thus in that case, the process presents only minimal additional user burden.

As a result, the described registration and authentication processes provide advantages over other methods of providing similar registration and/or authentication services for conducting transactions or obtaining services. These include, but are not limited to:
Enhanced security—because it is nearly impossible for a potential thief to steal a person's actual physical phone, even if the thief is able to obtain a user's password by use of social engineering, phishing, guessing or any other technique, they will not be able to gain access to the user's account without physical access to the user's phone which they will be unlikely to gain possession of;
Less user burden—compared to requiring strong passwords, or cumbersome biometrics procedures, or method adds very little burden to the end user of existing account registration or authentication processes; and
Faster detection of phishing: Users who visit a phishing site and enter their text credentials will know immediately, because the final step of the process (dialing the user's phone) will be difficult for a phishing attack to replicate, since the phishing attacker will likely not know the user's phone number. Thus, users will be able to recognize and detect phishing attempts faster.

A method of enhancing the security for transactions conducted over a network, such as eCommerce or a financial transaction conducted over the Internet has been described. The method utilizes a verification or authentication step conducted over a different communication channel that that used for the entry of data used to initiate the transaction. This additional security can be used as part of one or more of the registration, authentication, identity verification, or transaction acceptance/authorization functions that may be part of obtaining access to a service or conducting a transaction.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

What is claimed is:

1. A method of verifying the identity of a person initiating a transaction over a network, comprising:
obtaining credential data for the person as a result of the person providing the data over a first communication channel, the data including a telephone number for the person;
contacting the person using the telephone number over a second communication channel;
receiving verification data over the second communication channel;
comparing the received verification data to correct verification data; and
verifying the identity of the person if the received verification data matches the correct verification data.

2. The method of claim 1, wherein the first communication channel is the Internet.

3. The method of claim 1, wherein the second communication channel is a telephony network.

4. The method of claim 1, wherein the second communication channel is a wireless data network.

5. The method of claim 3, wherein the telephony network is a fixed line network.

6. The method of claim 3, wherein the telephony network is a wireless network.

7. The method of claim 3, wherein the telephony network is a VoIP network.

8. The method of claim 1, wherein the received verification data is an alphanumeric character string.

9. The method of claim 1, wherein the received verification data is a spoken phrase.

10. The method of claim 1, wherein the credential data is provided by the person using a text message generated using a mobile phone interface.

11. The method of claim 1, wherein the verification data is provided by the person by dialing a specified phone number and entering the data or speaking the data.

12. The method of claim 1, wherein the transaction is an eCommerce transaction, the credential data includes an order for a product or service, and the method further comprises completing the order for the product or service after verifying the identify of the person.

13. The method of claim 1, wherein the transaction is a financial transaction, the credential data includes a request for a financial operation, and the method further comprises completing the financial operation after verifying the identify of the person.
